(19) United States
(12) Patent Application Publication
(10) Pub. No.: US 2007/0092237 A1
(43) Pub. Date: Apr. 26, 2007

(54) Upright camcorder with a dual lens assembly

(75) Inventor: Byoeng-su Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/411,814

(22) Filed: Apr. 27, 2006

(30) Foreign Application Priority Data
Oct. 24, 2005 (KR) 2005-100383

(51) Int. Cl. G03B 17/00

(52) U.S. Cl. 396/72

(57) ABSTRACT

An upright camcorder with a dual lens is provided. The upright camcorder has two lenses disposed on one lens barrel part. The lens barrel part is connected to a main body by a hinge unit so that it can be rotated with respect to the main body. One of the lenses is a first lens with a high number of pixels for photographing a still image, and the other lens is a second lens for photographing a moving image. The upright camcorder has each lens so that high quality still and moving images can be obtained. Further, a user can photograph images at various angles. Therefore, the camcorder is convenient.

### CROSS-REFERENCE TO RELATED APPLICATIONS

This application claims the benefit of Korean Patent Application No. 2005-100383 filed on Oct. 24, 2005, in the Korean Intellectual Property Office, the entire disclosure of which is hereby incorporated by reference.

### BACKGROUND OF THE INVENTION

1. Field of the Invention

The present invention relates to an image photographing apparatus. More particularly, the present invention relates to an upright camcorder, which has a dual lens assembly disposed on a rotatable lens barrel.

2. Description of the Related Art

Generally, a digital camcorder has more functions and a more complicated configuration than a digital still camera. Therefore, it has a comparatively larger volume and is more expensive than a digital still camera. To reduce the size of a camcorder, a compact and lightweight upright camcorder has been developed, which uses a compact recording medium such as a hard disk drive or a flash memory.

FIGS. 1A and 1B show an example of a conventional upright camcorder. The upright camcorder employs a hard disk drive or a flash memory instead of a magnetic recording medium so that a deck unit is not required and the size of the unit can be significantly reduced. The upright camcorder 1 has a display part 14 disposed on a main body 10 instead of a general view finder to view a subject. The display part 14 includes a liquid crystal display (LCD) 14a. FIG. 1A shows the camcorder when the display part 14 is closed and FIG. 1B shows the camcorder when the display part 14 is opened.

The upright camcorder can photograph a moving image and a still image as well as a typical camcorder. However, typical camcorders have only one photographing lens 12a at a lens barrel part 12 and change the mode of the single lens to photograph a moving image or a still image. Therefore, the images photographed by the general camcorder are typically inferior to those photographed by a digital still camera. A compact lens having two modes is available. However, such a two mode lens has a very small range of functions. For example, such a lens may use a complementary metal oxide semiconductor (CMOS) image sensor, rather than a more sensitive charge-coupled device (CCD) image sensor, or the lens may be a single focus lens which does not have a zoom magnification feature.

Therefore, to obtain both high quality moving images and high quality still images, separate lenses for each type of image are included in one camcorder. If a separate, still image lens is provided in an upright camcorder, however, the size of the camcorder increases.

Accordingly, there is a need for an upright camcorder which has two lenses for obtaining high quality moving images and still images in a compact configuration.

### SUMMARY OF THE INVENTION

An aspect of the present invention is to address at least the above problems and/or disadvantages and to provide at least the advantages described below. Accordingly, an aspect of the present invention is to provide an upright camcorder which has, at opposite ends of a lens barrel, a lens for photographing a moving image and a lens for photographing a still image, so that the size of the camcorder is compact and high quality moving images and still images can be obtained.

Another aspect of the present invention is to provide an upright camcorder in which the lens barrel part with lenses for moving images and still images can be rotated by various angles with respect to a main body so that a user can photograph moving images and still images at various angles.

In accordance with an aspect of the present invention, an upright camcorder comprises a main body, a display part rotatably engaged with the main body, a lens barrel part engaged with the main body, the lens barrel part comprising a dual lens disposed at opposite ends of the lens barrel part, and a hinge unit rotatably connecting the lens barrel part to the main body.

The dual lens may comprise a first lens and a second lens generally aligned along the same optical axis, with the first and second lenses facing opposite directions.

The first lens may be adapted to photograph a still image, and the second lens may be adapted to photograph a moving image.

The first and second lenses may comprise zoom lenses.

The lens barrel part may comprise a first zoom operation part disposed adjacent to the first lens to operate the first lens and a second zoom operation part disposed adjacent to the second lens to operate the second lens.

The lens barrel part may be capable of being rotated with respect to the main body in one direction by at least 270 degrees.

The hinge unit may comprise a first bracket disposed on the main body, the first bracket having a cam part, a second bracket disposed on the lens barrel part, the second bracket being rotatably connected to the first bracket, and an elastic member disposed between the first bracket and the second bracket. The configuration of the elastic member may correspond to the configuration of the cam part of the first bracket.

A profile of the cam part may comprise a convex portion adjacent to a concave portion.

A conversion mode switch to change between a moving image mode and a still image mode may be provided.

The lens barrel part may comprise a sensor which senses rotation of the lens barrel part to change between a moving image mode and a still image mode when the lens barrel part is rotated with respect to the main body.

The display part may be engaged with a side of the main body, and the lens barrel part may be engaged with a top of the main body.

In accordance with another aspect of the present invention, an upright camcorder comprises a main body, a display part rotatably engaged with the main body, a lens barrel part engaged with the main body, the lens barrel part comprising a dual lens assembly disposed at opposite ends of the lens barrel part, and a hinge unit rotatably connecting the lens barrel part to the main body.

The dual lens assembly may comprise a first lens and a second lens generally aligned along the same optical axis, with the first and second lenses facing opposite directions.

The first lens assembly may comprise a first lens, a first lens holder enclosing the first lens, a first image sensor disposed at a rear portion of the first lens holder, and a first image sensor substrate connected to the first image sensor.

The first image sensor may comprise a CCD image sensor.

The second lens assembly may comprise a second lens, a second lens holder enclosing the second lens, a second image sensor disposed at a rear portion of the second lens holder, and a second image sensor substrate connected to the second image sensor.

The second image sensor may comprise a CCD image sensor.

The first image sensor may have a higher resolution than the second image sensor.

The display part may be engaged with a side of the main body, and the lens barrel part may be engaged with a top of the main body.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1A is a perspective view of a conventional upright camcorder, with a display part on the camcorder closed;

FIG. 1B is a perspective view of the upright camcorder of FIG. 1B, with the display part opened;

FIG. 2 is a perspective view of an upright camcorder according to an exemplary embodiment of the present invention;

FIG. 3A is an exploded perspective view of a first lens assembly attached to a lens barrel part of the upright camcorder of FIG. 2;

FIG. 3B is an exploded perspective view of a second lens assembly attached to a lens barrel part of the upright camcorder of FIG. 2;

FIG. 4 is an exploded perspective view of a hinge unit of FIG. 2; and

FIGS. 5 through 7 are perspective views of the upright camcorder of FIG. 2 in different operational configurations.

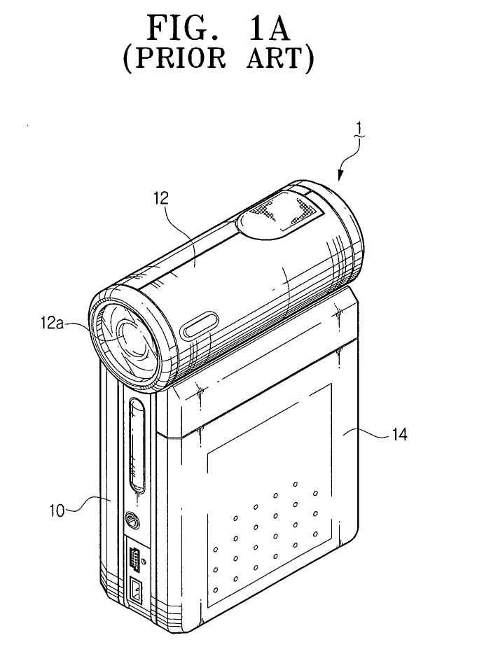

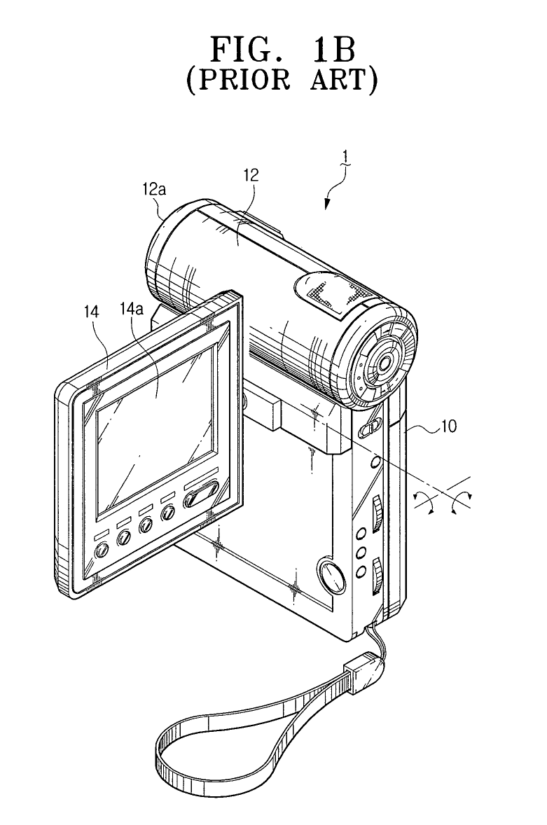

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

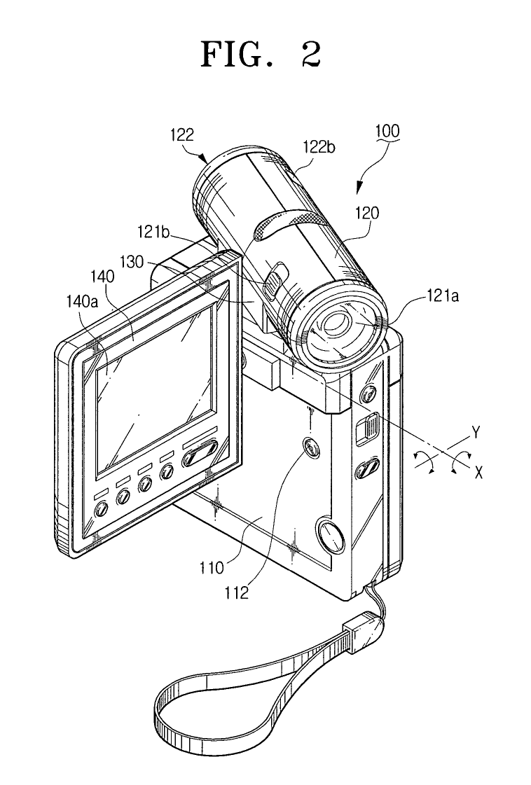

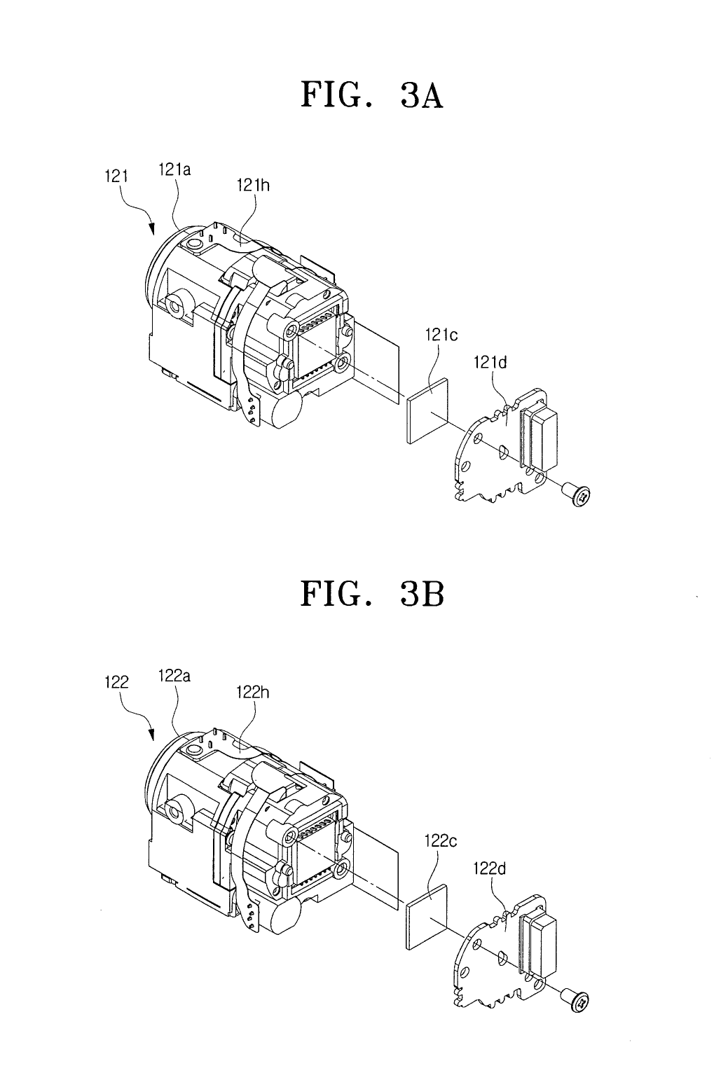

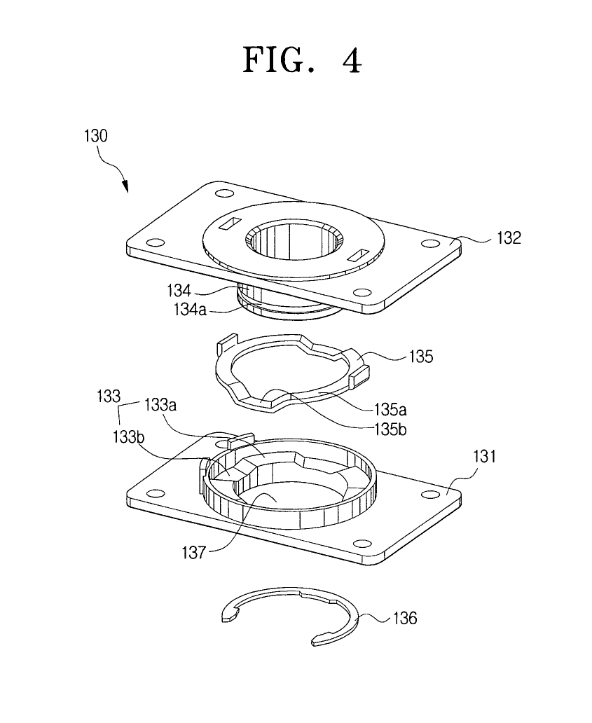

FIG. 2 is a perspective view of an upright camcorder according to an exemplary embodiment of the present invention. FIG. 3A is an exploded perspective view of a first lens assembly attached to a lens barrel part of FIG. 2, and FIG. 3B is an exploded perspective view of a first lens assembly attached to a lens barrel part of FIG. 2. FIG. 4 is an exploded perspective view of a hinge unit of the camcorder.

Referring to FIGS. 2 through 4, an upright camcorder 100 according to an exemplary embodiment of the present invention comprises a main body 110, a display part 140 engaged with a side of the main body 110, a lens barrel part 120 engaged with a top portion of the main body 110, and a hinge unit 130 rotatably connecting the lens barrel part 120 to the main body 110.

A data storage medium such as a hard drive or a flash memory (not shown) is disposed in the main body 110. The image data photographed by each lens 121a, 122a is stored by the data storage medium. The display part 140 may be pivotably connected to the main body 110 so that it can be pivoted about both the x and y axes. The display part 140 includes a liquid crystal display (LCD) 140a for displaying images photographed by each lens 121a, 122a.

As shown in FIG. 3, a dual lens assembly is attached to the lens barrel part 120. The dual lens assembly is composed of a first lens assembly 121 and a second lens assembly 122. The optical axes of the first and second lens assemblies 121, 122 are generally aligned along the same optical axis. The first lens assembly, however, is aligned so that it faces the opposite direction that the second lens assembly 122 faces.

The first lens assembly 121 comprises a first lens 121a, a first lens holder 121h enclosing the first lens 121a, a first image sensor (such as a charge-coupled device (CCD) sensor) disposed at a rear portion of the first lens holder 121h, and a first image sensor substrate 121d connected to the first CCD 121c as shown in FIG. 3A. The first lens 121a may be, in an exemplary embodiment, a zoom lens.

The second lens assembly 122 comprises a second lens 122a, a second lens holder 122h enclosing the second lens 122a, a second image sensor (such as a CCD sensor) disposed at a rear portion of the second lens holder 122h, and a second image sensor substrate 122d connected to the second image sensor 122c as shown in FIG. 3B. The second lens 122a may be, in an exemplary embodiment, a zoom lens.

The lens barrel part 120 includes a first zoom operation part 121b formed adjacent to the first lens 121a to cause the first lens 121a to zoom in and out. A second zoom operation part 122b is formed adjacent to the second lens 122a to cause the second lens 122a to zoom in and out.

The lens assemblies 121, 122 are disposed in the same lens barrel part 120 so that they are symmetrical with respect to one another. The first lens assembly 121 may have an image sensor with a different number of pixels, for example, a higher number of pixels, than that of the second lens assembly 122. Accordingly, the first lens assembly 121 may typically be used for photographing a high quality of image, for example, a still image.

The first lens assembly 121 may have a digital still camera lens.

The second lens assembly 122 may be used for photographing a relatively lower quality of image than the first lens assembly 121, that is, an image with a relatively lower number of pixels. As is well known to those skilled in the art, the image sensors 121d, 122d convert an optical image incident on the sensors through the lenses 121a, 122a into an electrical signal.

If a user tries to photograph a moving image or a still image, by using the upright camcorder 100, the lens barrel part 120 including the dual lens assembly need be rotated. To this end, the hinge unit 130 is disposed between the main body 110 and the lens barrel part 120 so that the lens barrel part 120 can be rotated by a certain angle with respect to the main body 110.

Referring to FIG. 4, the hinge unit 130 comprises a first bracket 131, a second bracket 132, and an elastic member 135.

The first bracket 131 is disposed on the main body 110 and includes a cam part 133. The profile of the cam part 133 of the first bracket has a convex portion 133a adjacent to a concave portion 133b. The profile of the elastic member 135 has a convex portion 135a and a concave portion 135b corresponding to the cam part 133.

The second bracket 132 is fixed onto the lens barrel part 120 and a connection member 134 extends downwardly from a central portion of the second bracket 132. The connection member 134 is inserted into a shaft opening 137 of the first bracket 131. Then, a fixing ring 136 is fastened with a recess 134a of an end portion of the connection member 134 so that the connection member 134 can rotate with respect to the first bracket 131.

The elastic member 135 is disposed between the first bracket 131 and the second bracket 132 and has a profile corresponding to the surface configuration of the cam part 133 of the first bracket 131. The elastic force of the elastic member 135 pressurizes the first bracket 131 and the second bracket 132 so that the lens barrel part 130 can be rotated and stopped at an angle with respect to the main body 110. FIG. 2 shows the lens barrel part 120 of the camcorder 100 rotated and stopped at an angle with respect to the main body 110.

It should be understood that the just described hinge structure is merely an example of a suitable hinge, and the present invention is not limited to that particular hinge unit.

Due to the hinge unit 130, the lens barrel part 120 can be rotated from an initial state in one direction by at least 270 degrees. Therefore, the camcorder can be adjusted to photograph in 360 degrees with respect to the main body 110.

The upright camcorder 100 can switch modes between photographing a moving image and photographing a still image in two methods according to the rotating of the lens barrel part 120.

In the first method, a mode conversion switch 113 is formed on an operation panel of the main body 110 to place the photographing modes into a desired mode before photographing. In this case, the mode is not converted by a change of the rotational direction of the lens barrel part 120. Therefore, the camcorder 100 can photograph in one photographing mode at varying photographing angles.

In the second method, the photographing mode can be switched according to the output of a sensor when the lens barrel part 120 is rotated. The lens barrel part 120 may have a sensor (not shown), which senses the rotation of the lens barrel part 120 so as to automatically change from a moving image mode to a still image mode or from a still image mode to a moving image mode when the lens barrel part 120 is rotated with respect to the main body 110. In this case, when the lens barrel part 120 is rotated by a certain angle, the mode is changed so that a user is not required to operate the mode conversion switch 113. This mode may be more convenient for an operator.

Various examples of the operation of the upright camcorder according to an exemplary embodiment of the present invention will now be explained.

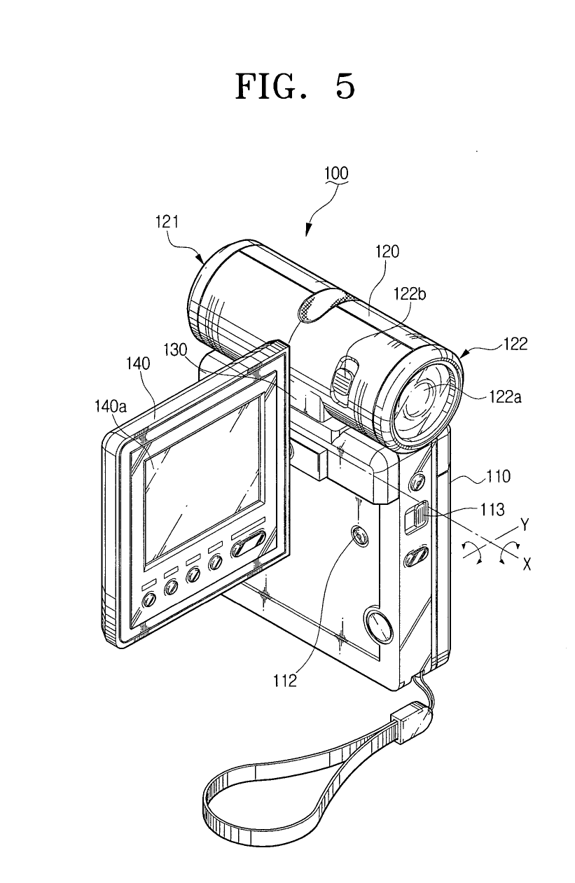

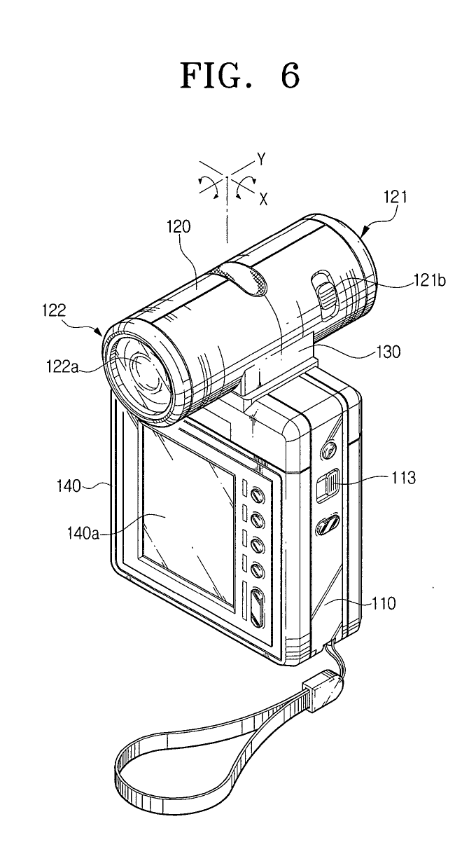

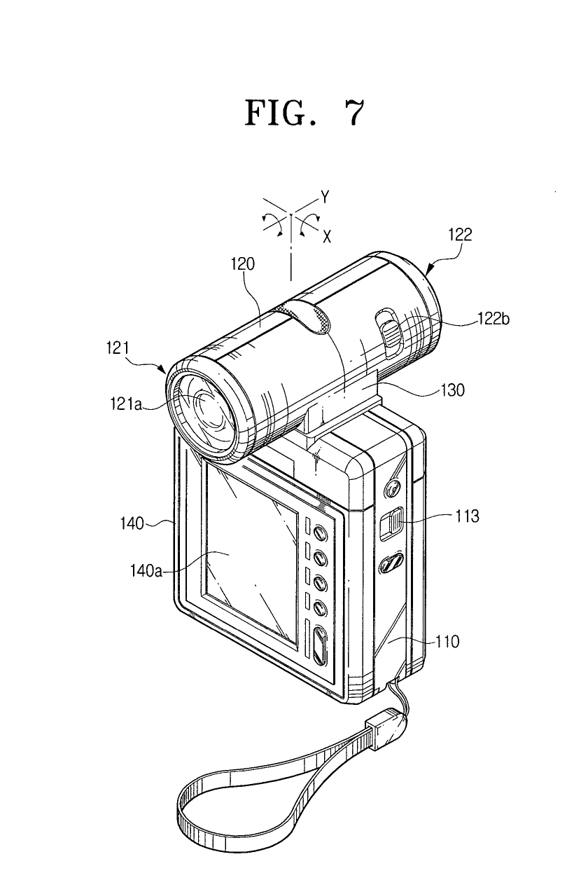

FIGS. 5 through 7 are perspective views showing the upright camcorder being operated at various photographing angles according to an exemplary embodiment of the present invention. In FIGS. 5 and 6, the upright camcorder is being in a still image photographing mode. In FIG. 7, the upright camcorder is in a moving image photographing mode.

As shown in FIG. 2, a power switch 112 of the main body 110 is turned on and the display part 140 is opened so that the second lens 122a is positioned to face toward the subject to photograph a moving image. If a still image of the subject need be photographed while a moving image is being photographed, the mode conversion switch 113 is changed to the still image mode and the lens barrel part 120 is rotated by 180 degrees with respect to the main body 110, as shown in FIG. 5. In this configuration, the lens barrel part the first lens 121a of the lens barrel part 120 faces toward the subject and a still image can be photographed.

The camcorder 100 has the zoom operation part 122b at the lens barrel part 120 so that an operator may zoom in and out while the still image is photographed.

Additionally, while photographing in the configuration shown in FIG. 5, the display part 140 may be folded to the configuration shown in FIG. 6, and the lens barrel part 120 may be rotated by 90 degrees so that a user may more conveniently photograph a still image.

To photograph a moving image with the camcorder 100, the mode conversion switch 113 is changed to the moving image mode and the lens barrel part 120 is rotated to the configuration shown in FIG. 2 or FIG. 7. In this configuration, the second lens 122a of the lens barrel part 120 faces toward the subject so that a moving image may be photographed.

In particular, as shown in FIG. 7, the camcorder 100 has the display part 140 folded in the same configuration as that of FIG. 6 so that a user may see the LCD 140a. Then, the lens barrel part 120 may be rotated perpendicularly to the main body 110 so that a moving image may be photographed. As compared to the configuration shown in FIG. 2, this configuration may be more convenient in certain situations.

The zoom operation part 121b is disposed on the lens barrel part 120 so that an operator may zoom in and out when a moving image is photographed.

Thus, during the operation of an upright camcorder according to an exemplary embodiment of the present invention, various photographing angles may be formed so that a moving image and a still image can be easily and conveniently photographed and high quality images may be obtained.

Further, the upright camcorder according to an exemplary embodiment of the present invention has a dual lens assembly on a lens barrel part and the lens barrel part may be rotated with respect to a main body. Therefore, a user may photograph images at various angles, and a high quality moving images and still image may be obtained.

Moreover, even though the camcorder has two kinds of lenses, the upright camcorder has the same size as a conventional upright camcorder. Plus, the upright camcorder can be conveniently operated by a consumer.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An upright camcorder comprising:
a main body;
a display part rotatably engaged with the main body;
a lens barrel part engaged with the main body, the lens barrel part comprising a dual lens disposed at opposite ends of the lens barrel part; and
a hinge unit rotatably connecting the lens barrel part to the main body.

2. The upright camcorder according to claim 1, wherein
the dual lens comprises a first lens and a second lens generally aligned along the same optical axis, the first and second lenses facing opposite directions.

3. The upright camcorder according to claim 2, wherein
the first lens is adapted to photograph a still image, and the second lens is adapted to photograph a moving image.

4. The upright camcorder according to claim 2, wherein
at least one of the first and second lenses comprises a zoom lens.

5. The upright camcorder according to claim 2, wherein the lens barrel part comprises:
a first zoom operation part disposed adjacent to the first lens to operate the first lens, and;
a second zoom operation part disposed adjacent to the second lens to operate the second lens.

6. The upright camcorder according to claim 1, wherein
the lens barrel part is able to rotate with respect to the main body in one direction by at least 270 degrees.

7. The upright camcorder according to claim 1, wherein the hinge unit comprises:
a first bracket disposed on the main body, the first bracket having a cam part;
a second bracket disposed on the lens barrel part, the second bracket being rotatably connected to the first bracket; and
an elastic member disposed between the first bracket and the second bracket, the configuration of the elastic member corresponding to the configuration of the cam part of the first bracket.

8. The upright camcorder according to claim 7, wherein
a profile of the cam part comprises a convex portion adjacent to a concave portion.

9. The upright camcorder according to claim 1, further comprising
a conversion mode switch to change between a moving image mode and a still image mode.

10. The upright camcorder according to claim 1, wherein
the lens barrel part comprises a sensor which senses rotation of the lens barrel part to change between a moving image mode and a still image mode when the lens barrel part is rotated with respect to the main body.

11. The upright camcorder according to claim 1, wherein
the display part is engaged with a side of the main body, and
the lens barrel part is engaged with a top of the main body.

12. An upright camcorder comprising:
a main body;
a display part rotatably engaged with the main body;
a lens barrel part engaged with the main body, the lens barrel part comprising a dual lens assembly disposed at opposite ends of the lens barrel part; and
a hinge unit rotatably connecting the lens barrel part to the main body.

13. The upright camcorder according to claim 12, wherein
the dual lens assembly comprises a first lens and a second lens generally aligned along the same optical axis, the first and second lenses facing opposite directions.

14. The upright camcorder according to claim 13, wherein the first lens assembly comprises:
a first lens;
a first lens holder enclosing the first lens;
a first image sensor disposed at a rear portion of the first lens holder; and
a first image sensor substrate connected to the first image sensor.

15. The upright camcorder according to claim 14, wherein
the first image sensor comprises a CCD image sensor.

16. The upright camcorder according to claim 14, wherein the second lens assembly comprises:
a second lens;
a second lens holder enclosing the second lens;
a second image sensor disposed at a rear portion of the second lens holder; and
a second image sensor substrate connected to the second image sensor.

17. The upright camcorder according to claim 16, wherein
the second image sensor comprises a CCD image sensor.

18. The upright camcorder according to claim 16, wherein
the first image sensor has a higher resolution than the second image sensor.

19. The upright camcorder according to claim 13, wherein the second lens assembly comprises:
a second lens;
a second lens holder enclosing the second lens;
a second image sensor disposed at a rear portion of the second lens holder; and
a second image sensor substrate connected to the second image sensor.

20. The upright camcorder according to claim 12, wherein
the display part is engaged with a side of the main body, and
the lens barrel part is engaged with a top of the main body.
